(19) United States
(12) Patent Application Publication
(10) Pub. No.: US 2025/0213062 A1
(43) Pub. Date: Jul. 3, 2025

(54) BREWING DEVICE

(71) Applicants: Han-Chun Lin, Taichung City (TW); JEAJIA CO., LTD., Taichung City (TW)

(72) Inventor: Han-Chun Lin, Taichung City (TW)

(21) Appl. No.: 18/398,156

(22) Filed: Dec. 28, 2023

(51) Int. Cl. A47J 31/18; A47J 31/06; A47J 31/44

(52) U.S. Cl. CPC A47J 31/18; A47J 31/0615; A47J 31/4407

(57) ABSTRACT

A brewing device includes a container, a filter net assembly, a gas guide tube, a cover assembly, and a lift grip. The cover assembly includes a cover and a connecting member. The gas guide tube is combinable with the connecting member so as to combine the cover and the filter net assembly together. The lift grip is connected to the cover assembly to allow hand-holding of the lift grip for moving the cover assembly and the filter net assembly. The filter net assembly is retained in a retaining portion of a container opening portion of the container. An annular gap is formed between the cover and an inside surface of the container opening portion. A water filling trough is formed, as being downward recessed, between the cover and the container opening of the container. The gas guide tube is in communication with a liquid storage space of the container.

### TECHNICAL FIELD OF THE INVENTION

The present invention relates to a brewing device, and more particularly to a brewing device that includes a gas guide tube arranged in communication with a filter net assembly to discharge air from a container.

### DESCRIPTION OF THE PRIOR ART

To brew up tea is an important leisure activity in the living or work of the public. Brewing tea makes human minds calm, while drinking tea makes people vigorous and energetic. Catechins contained in tea has numerous advantages including super oxidization resistance, release of greasy taste, and promotion of metabolism.

Modern people are very busy in work and live in a very tight schedule, and thus a tea brewing tool that is efficient and easy to operate for assistance of tea brewing would suit the needs of the modern people. The tea brewing tools have constantly evolved in respect of the structure, see for example Taiwan Utility Model application No. 110210481, “Brewing device and filter assembly thereof”. The known Utility Model provides an advantage of pouring in hot water without moving off a lid, and also overcomes an issue that hot water cannot flow downward or flow with a slow speed due to the effect of surface tension of water. Yet, the following defects are incurred.
(1) The filter assembly protrudes outside of a top end of a container, so that the overall height of the brewing device is increased, leading to an issue of being hard to stow. Further, the filter assembly is made of stainless steel, so that in pouring out tea, the weight of the filter assembly in combination with the tea flowing to the opening leads to an issue of being top-heavy, making the hands of the user bearing a large loading.
(2) As shown in FIG. 5 of the document, a sealing ring is set in a tight and hermetic condition with respect to the opening of the container, so that, when poured out, the tea is blocked by the sealing ring, and as such, tea cannot be completely poured out, and contamination and dirt may be easily accumulated at the joining site of the sealing ring and the opening of the container.
(3) A central filtering hole is excessively large, so that small pieces of tea leaves may also be poured out, leading to undesired influence on the mood of enjoying tea drinking.

### SUMMARY OF THE INVENTION

An objective of the present invention is to provide a brewing device, which includes a cover and a filter net assembly that are combined and fixed together by means of a combination of a connecting member and a gas guide tube, so that when the cover and the filter net assembly are fixed in a container opening portion of a container, two opposite ends of the gas guide tube are respectively in communication with inside and outside of the container to quickly discharge air in the interior of the container to the outside and to allow hot water, which is being poured into the container and flowing through the filter net assembly, to quickly flow into a liquid storage space of the container.

Another objective of the present invention is to provide a brewing device, which includes a retaining portion formed in an inside surface of a container opening portion of a container to have a filter net assembly retained at a location corresponding to the retaining portion, and a cover arranged at a location above the filter net assembly and below a container opening to define a downwardly recessed water filling trough between a top surface of the cover and the container opening, such that in each time of re-filling hot water, there is no need to remove the cover and the filter net assembly first and thus re-filling hot water can be done directly and easily.

As such, the present invention provides a brewing device, which comprises a container, a filter net assembly, a gas guide tube, a cover assembly, and a lift grip;
wherein the container is formed, in an interior thereof, with a liquid storage space, which has an upper end that forms a container opening portion in communication with the liquid storage space, and an inside surface of the container opening portion forms a retaining portion, and the container opening portion is further formed with a container opening for water ingress and water egress;
the filter net assembly comprises filter pores that allows water to flow in and out and prevents tea leaves from flowing out and comprises a central through-hole to receive a gas guide tube to rotatably extend therethrough; and the filter net assembly is positionable, in a direction from top to bottom, into the container opening portion and is retained by the retaining portion from further moving downward;
the gas guide tube comprises a gas channel, extending through two opposite ends thereof and has an outer circumferential surface that is formed with an external thread, and has a bottom that is formed with a stop portion, and penetrates through the central through-hole of the filter net assembly to screw to a connecting member for combining therewith;
the cover assembly comprises a connecting member and a cover, wherein the connecting member is formed with a threaded hole and has an end combined with the cover and an opposite end that is screwed, through the threaded hole thereof, with an external thread of the gas guide tube to combine the cover and the filter net assembly together; and the cover comprises a circular plate, which has an outside diameter smaller than an inside diameter of the container opening portion; and the lift grip comprises a longitudinal extension portion and a gripping portion, wherein the gripping portion is connected to the longitudinal extension portion, and the longitudinal extension portion is connected to the cover assembly;
wherein by means of the above structural arrangement, the cover assembly and the filter net assembly are combined together by means of the gas guide tube and the connecting member and are positionable together into the container opening portion of the container, such that the filter net assembly is retained by the retaining portion and is not movable downward without being acted upon by an external force applied thereto, and an annular gap is formed between a cover external circumferential rim and an inside surface of the container opening portion, and a top surface of the cover and the container opening define therebetween a downward recessed water filling trough, and the gas guide tube is in communication with the liquid storage space of the container.

Due to the water filling trough defined between the cover and the container opening, it is possible to directly pour hot water onto the cover without first removing the cover, and the hot water flow along the cover into the liquid storage space, and air in the liquid storage space can be removed as being discharged through the gas guide tube to allow the hot water to quickly flow into the liquid storage space. Further, the cover and the filter net assembly are arranged inside the container opening portion, and unlike the prior art in, this makes no protrusion to the outside of the container, and thus, the brewing device, as a whole, does not cause problems of being excessively high and being in a top-heavy condition.

### BRIEF DESCRIPTION OF THE DRAWINGS

FIG. 1 is an exploded view of the present invention.

FIG. 2 is a perspective view, partly assembled, of FIG. 1.

FIG. 3 is a perspective view, in an assembled form, of FIG. 1.

FIG. 4 is a cross-sectional view showing use of the present invention.

FIG. 5 is schematic view of the present invention, showing a lift grip connected to a cover.

FIG. 6 is a cross-sectional view showing a connecting member according to another embodiment the present invention and applied to a brewing device.

FIG. 7 is a cross-sectional view showing a connecting member according to a third embodiment the present invention and applied to a brewing device.

FIG. 8 is a cross-sectional view showing the lift grip connected to a top portion of the cover according to the present invention and applied to a brewing device.

FIG. 9 is a cross-sectional view showing a container according to another embodiment of the present invention and applied to a brewing device.

### DETAILED DESCRIPTION OF THE PREFERRED EMBODIMENT

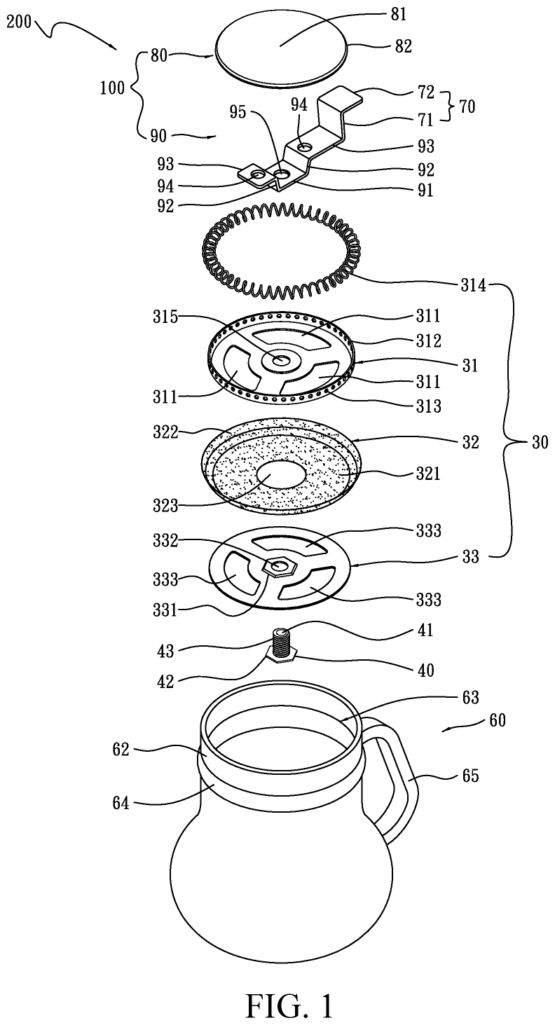

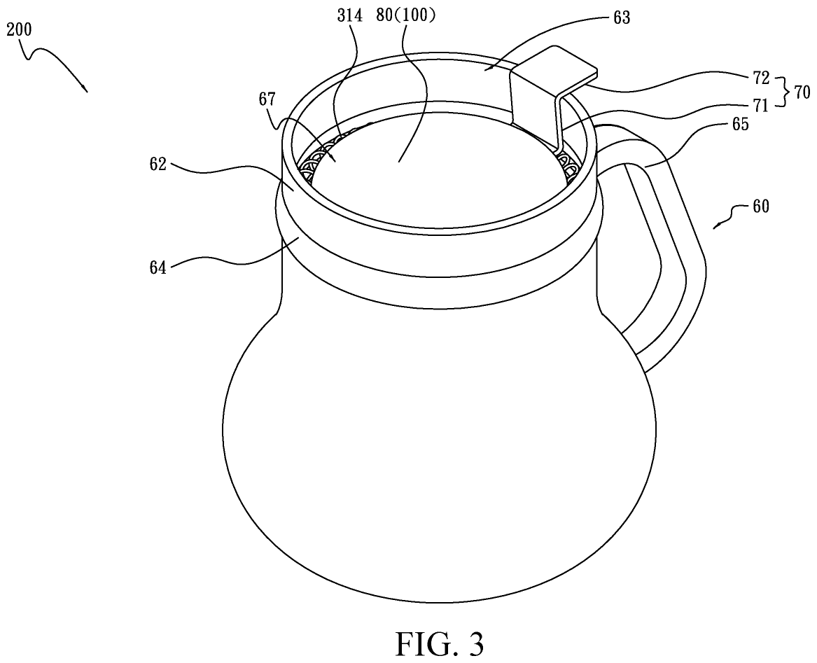

Referring to FIGS. 1-4, a brewing device according to a first embodiment of the present invention is presented, and comprises: a container 60, a filter net assembly 30, a gas guide tube 40, a cover assembly 100, and a lift grip 70.

The container 60 is formed in an interior thereof with a liquid storage space 61, which has an upper end that forms a container opening portion 62 in communication with the liquid storage space 61. The container opening portion 62 has an inside surface in which a retaining portion 64 is formed. In the embodiment, the retaining portion 64 is formed as an annular groove. The container opening portion 62 is formed, in a top end thereof, with a container opening 63 for water ingress and water egress. The container 60 is further provided, on a lateral side thereof, with a handle 65 for hand holding by a user. The container 60 can be made of a material of plastic or ceramic or glass or stainless steel.

The filter net assembly 30 comprises, in sequence from top to bottom thereof, a spring ring 314, an upper fixing plate 31, a net plate 32, and a lower fixing plate 33. The upper fixing plate 31, the net plate 32, and the lower fixing plate 33 are respectively formed with central through-holes 315, 323, 332 that are concentrical with respect to each other. The upper fixing plate 31 and the lower fixing plate 33 are each formed with a plurality of water flow-through zones 311, 333 penetrating therethrough in a top-bottom direction. The upper fixing plate 31 has an external annular edge that is formed with an annular raised flange 312 that is raised upward, and the annular raised flange 312 is formed with apertures that are arranged at intervals. The apertures 313 receive the spring ring 314 to extend, in a rotatable manner, therethrough in order to have the spring ring 314 and the upper fixing plate 31 combined together and the spring ring 314 circumferentially surrounds the external annular edge of the upper fixing plate 31. If desired, the spring ring 314 can be alternatively combined with the lower fixing plate 33. The net plate 32 is formed of thin stainless wires in weft-direction and warp-direction intersecting each other and defining a plurality of tiny filter pores 321, and is deformable when acted upon by an external force, and has an external annular edge that is bent upward to form an annular curved rim 322 that is in closely matching engagement with the spring ring 314. The lower fixing plate 33 is formed, in a bottom thereof, with an upward-raised, non-circular retaining cavity 331 arranged around periphery of the central through-hole 332. The retaining cavity 331 can be of a rectangular or hexagonal shape. The upper fixing plate 31 and the lower fixing plate 33 have outside diameters that are the same as each other and are smaller than the net plate 32. The outside diameters of the upper fixing plate 31 and the lower fixing plate 33 are smaller than an inside diameter of the container opening portion 62. The spring ring and the net plate 32 of the filter net assembly 30 have an outside diameter that is greater than the inside diameter of the container opening portion 62 and smaller than or equal to the retaining portion 64 (which is in the form of an annular groove) of the container opening portion 62.

The gas guide tube 40 comprises a gas channel 41 extending through two opposite ends thereof and has an outer circumferential surface that is formed with an external thread 43, and has a bottom that is formed with a non-circular stop portion 42, the stop portion 42 being of a rectangular or hexagonal shape, and is set to penetrate, in a direction from bottom to top, through the central through-hole 315, 323, 332 of each of ingredient components of the filter net assembly 30 to screw with and connect to a connecting member 90, with the stop portion 42 received into the retaining cavity 331 of the lower fixing plate 33 to engage with each other for being retained together, so that in screwing the connecting member 90 with the gas guide tube 40, the gas guide tube 40 does not rotate therewith. The gas guide tube 40 can be made of a material of plastics or stainless steel. The gas guide tube 40 can be welded to or be integrally formed with the lower fixing plate as a one-piece structure.

The cover assembly 100 comprises a connecting member 90 and a cover 80. The connecting member 90 is made of a material of flexibility and elasticity, which includes a stainless steel plate or a plastic plate, and comprises a bottom plate 91. Two opposite ends of the bottom plate 91 are each folded upward to form a side plate 92. Each of the side plate 92 has a top end that is further formed with a bent edge portion 93 extending toward outside. An included angle between each of the side plates 92 and the bottom plate 91 is greater than 90 degrees. The bottom plate 91 is formed, in a center thereof, with a threaded hole 95 penetrating therethrough. Each of the bent edge portions 93 is formed with a through hole 94. The two bent edge portions 93 are combinable with the cover 80. The threaded hole 95 is screwed to the external thread 43 of the gas guide tube 40 so that the connecting member 90 and the filter net assembly 30 are fixedly combined together as being tightly fastened together by means of the bottom plate 91 of the connecting member and the stop portion 42 of the gas guide tube 40. The cover 80 comprises a circular plate and has a cover center top portion 81 that is higher than a cover external circumferential rim 82, an arc being formed between and extending from the cover center top portion 81 to the cover external circumferential rim 82, and has an inside bottom surface that is formed with two projecting pegs 83 that project downward. Each of the projecting pegs 83 is formed with a fitting notch 831 at a same height-wise location. The cover 80 has an outside diameter that is smaller than the inside diameter of the container opening portion 62, and the cover 80, when disposed into the container opening portion 62, forms an annular gap 811 with respect to an inside surface of the container opening portion 62. The cover 80 is combinable with the connecting member 90 and the two side plates of the connecting member 90 are arranged to expand outward. A force is applicable to the two side plates 92 to cause the two side plates 92 to move close to each other and becoming perpendicular to the bottom plate 91. And then, the through holes 94 of the two bent edge portions 93 are set to receive corresponding ones of the projecting pegs 83 to extend therethrough and the force applied to the two side plate 92 is released to allow the two side plate 92 to expand outward again by means of the springing effect thereof, making the through holes 94 of the two bent edge portions 93 tightly engaging with and retaining in the corresponding ones of the fitting notches 831 to combine the cover 80 and the connecting member 90 together, and as such, the cover 80, the connecting member 90, the gas guide tube 40, and the filter net assembly 30 are all combined together, while the cover and the filter net assembly 30 are spaced from each other by a distance due to the height of the two side plate 92. The cover 80 can be made of a material of plastic, ceramic, glass, or stainless steel.

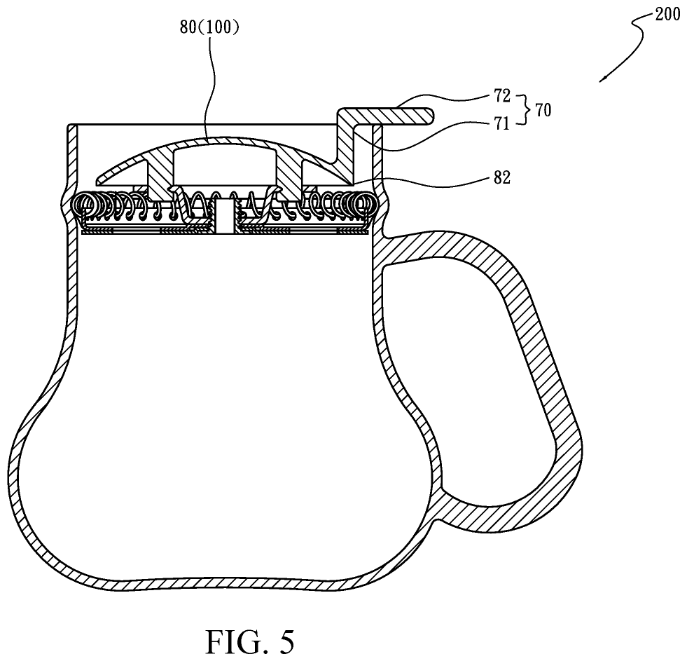

The lift grip 70 comprises a longitudinal extension portion 71 and a gripping portion 72, and in the embodiment, the longitudinal extension portion 71 is integrally connected with one of the bent edge portions 93 of the connecting member 90. The lift grip 70 can be alternatively structured as shown in FIG. 5, wherein the longitudinal extension portion is connected to the cover external circumferential rim 82, so that when the cover 80 is disposed into the container opening portion 62, the longitudinal extension portion 71 is located inside the container opening portion 62, and the gripping portion 72 is positionable, in a top-to-bottom direction, on and abutting an edge of the container opening 63 and extending outwards. The lift grip 70 can be made of a material of plastic or stainless steel.

Thus, the above provides an introduction to the components of the brewing device 200 provided in a preferred embodiment of the present invention, and the assembly thereof, and in the following operation features will be described.

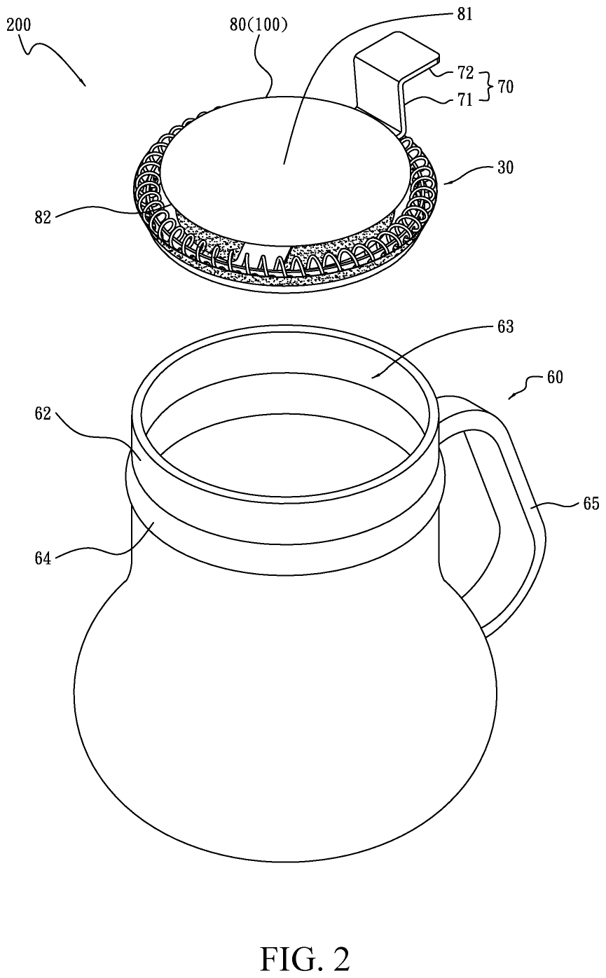

Further referring to FIGS. 2-4, tea leaves are first placed into the container 60, and a user holds, with a hand, the gripping portion 72 of the lift grip 70 to position the filter net assembly 30 and the cover assembly 100 into the container opening portion 62 of the container 60, wherein due to being smaller than the inside diameter of the container opening portion 62, the upper fixing plate 31 and the lower fixing plate 33 are allowed to smoothly pass therethrough, while the spring ring 314 and the net plate 32 are greater than the inside diameter of the container opening portion 62 and consequently, the spring ring and the net plate 32 are compressed by the inside surface of the container opening portion 62 and are shrunk and deformed to build up an elastic force therein, so that the spring ring 314 and the net plate 32 of the filter net assembly 30, when acted upon by a force to move downward to the site where the retaining portion 64 (namely the annular groove) is located, are caused by the elastic effect thereto to restore to the original shape and thus received into and retained in the retaining portion 64 (namely the annular groove) and the filter net assembly 30 and the cover 80, if no longer receiving a force acting thereon, do not further move downward, and oppositely, when a force is applied to act on the lift grip 72 to move the cover 80 and the filter net assembly 30 upwards, the spring ring 314 and the net plate 32 are compressed by the inside surface of the container opening portion to get shrunk and deformed again for smooth removal therefrom. As such, an effect of easy operation is achieved.

Further referring to FIGS. 2-4, when the filter net assembly 30 and the cover assembly are positioned into the container opening portion 62 of the container 60, the cover 80 is set at a location that is lower than an edge of the container opening 63, and the container opening 63 and a top surface of the cover 80 define a downward recessed water filling trough 67, and the gas guide tube 40 is set in communication with the liquid storage space of the container 60, so that due to the water filling trough 67 formed between the cover and the container opening 63, in re-filling hot water, the hot water can be directly poured onto the top of the cover 80 without the need to remove the cover 80, and hot water may flow, following the curvature of the cover 80, into the annular gap 811 to then move through gaps of the spring ring 314, the water flow-through zones 311, 333 of the upper fixing plate 31 and the lower fixing plate 333, and the filter pores 321 of the net plate 32 to get into the liquid storage space 61 to brew the tea leaves therein. As such, an easy operation can be realized in each time of re-filling hot water for not removing the cover 80, and further, the filter net assembly 30 and the cover 80 are generally of a light weight and are shaped to exhibit a flattened form so as not to protrude higher than the container opening portion 62 when positioned in the container opening portion 62, thereby not increasing the original height of the brewing device 200 and not causing an issue of being top heavy.

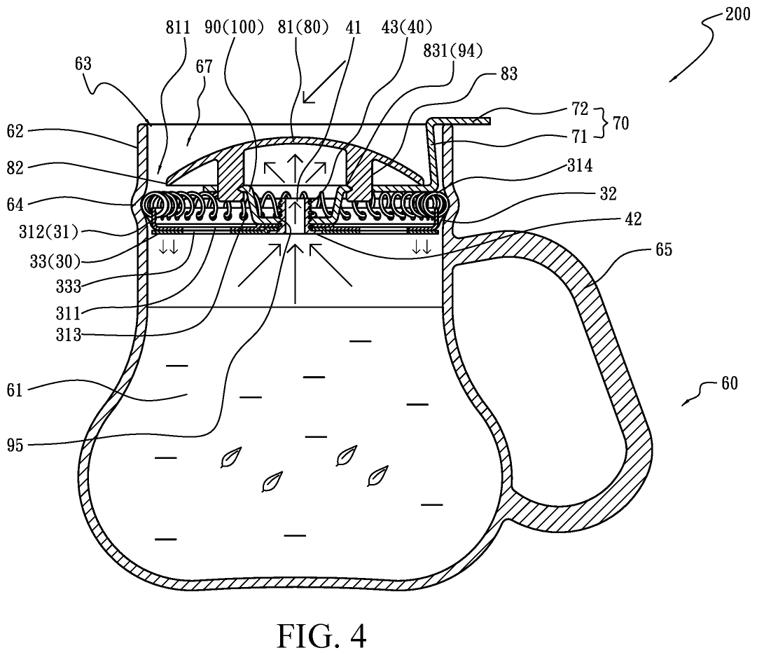

Further referring to FIG. 4, when the filter net assembly 30 and the cover assembly are positioned in the container opening portion 62 of the container 60, the gas guide tube 40 is in communication with the liquid storage space 61 of the container 60, and air in the liquid storage space 61 can be discharged out by way of the gas channel 41 of the gas guide tube 40, so that the hot water is not affected by the effect of surface tension to not flow into or only flow at a slow speed into the liquid storage space 61 and thus, tea brewing can be performed smoothly.

Further referring to FIG. 4, when the filter net assembly 30 and the cover assembly are fit into the retaining portion 64 (namely the annular groove) of the container opening portion 62 of the container 60, the net plate 32 is set to span across the inside surface of the retaining portion 64 (namely the annular groove), and due to the fine filter pores of the net plate 32, in pouring brewed tea, the tea leaves do not pass through the net plate 32, and thus, the brewed tea water does not contain tea leaves and the interest of enjoying tea drinking is not affected.

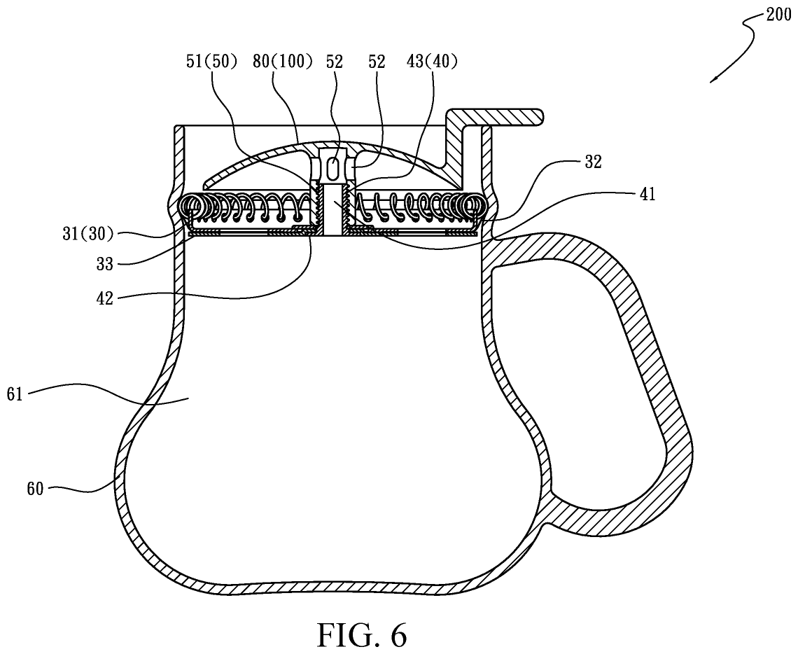

Further referring to FIG. 6, a connecting member 50 of the brewing device 200 according to a second embodiment of the present invention is provided. The connecting member 50 is a hollow tubular body that is formed, as being directly molded, on a center of a bottom of the cover 80 and is provided, in a bottom portion thereof, with a threaded hole and is provided, in an outer circumferential surface of a top portion thereof, with a plurality of gas openings 52, wherein the threaded hole 51 is screwable onto the external thread 43 of the gas guide tube 40 and the connecting member 50 is set in communication with the gas guide tube 40, such that the bottom thereof is in tight abutting engagement with the stop portion 42 of the gas guide tube 40 to be securely fixed to and combined with the filter net assembly 30 and the plurality of gas openings 52 formed in the top thereof allow air that enters the gas channel 41 of the gas guide tube 40 to be discharged out by way of each of the gas openings 52, and as such, an effect of allowing hot water to quickly flow into the liquid storage space 61 can be similarly achieved to make tea brewing performed smoothly. In the instant embodiment, the inside bottom surface of the cover 80 does not need to provide the two projecting pegs 83 as shown in FIG. 4.

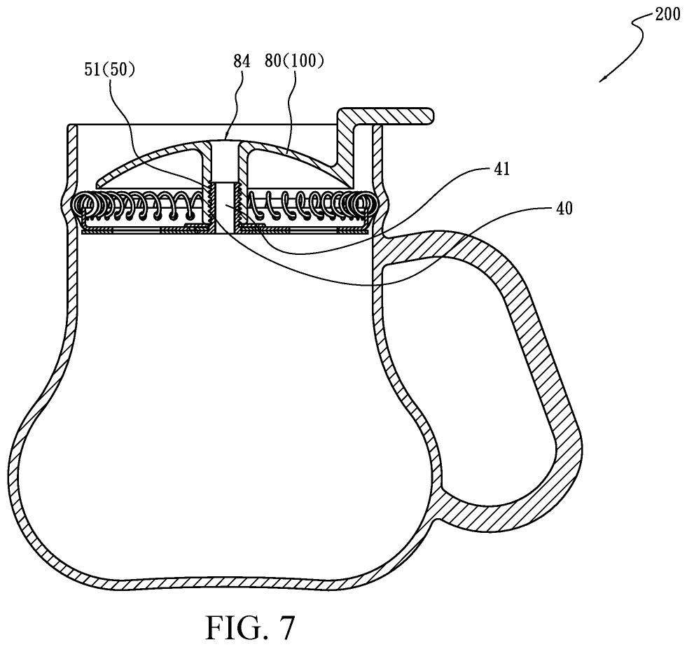

Further referring to FIG. 7, a different embodiment is provided for the connecting member 50 and the cover 80 shown in FIG. 6, wherein a difference is that the cover 80 is formed with a gas passage hole 84 at a location corresponding to the hollow tubular body of the connecting member 50 to be in communication with an interior of the connecting member 50, while no gas openings are formed in the outer circumferential surface of the top portion of the connecting member 50, wherein by means of the gas passage hole 84 provided in the cover 80, air that enters the gas channel 41 of the gas guide tube 40 is allowed to discharge out through the gas passage hole 84 of the cover 80, and as such, an effect of allowing hot water to quickly flow into the liquid storage space 61 can be similarly achieved.

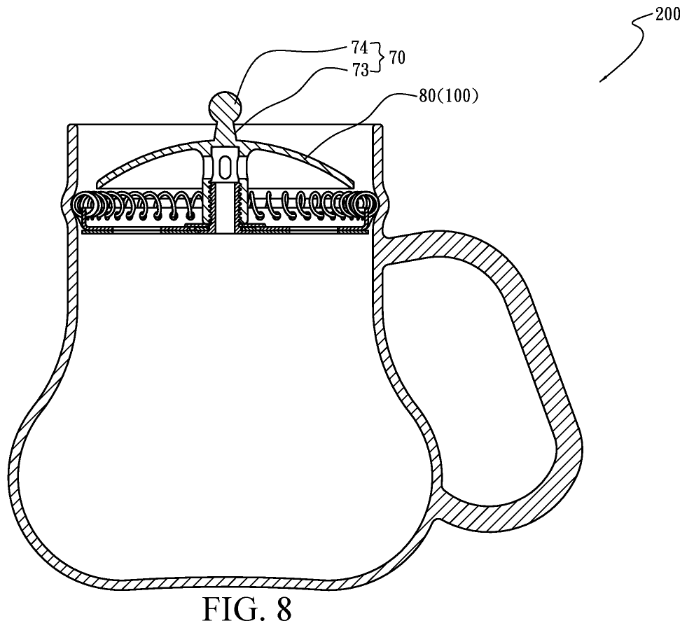

Further referring to FIG. 8, a different embodiment is provided for the lift grip 70 according to the present invention, wherein the lift grip 70 similarly comprises a longitudinal extension portion 73 and a gripping portion 74, and the longitudinal extension portion 73 is made in the form of a post combined with and fixed to an outside top surface of the cover 80, and the gripping portion 74 is connected to the longitudinal extension portion 73 to form a sphere. As such, a different way of holding and removing the cover assembly 100 and the filter net assembly 30 is provided.

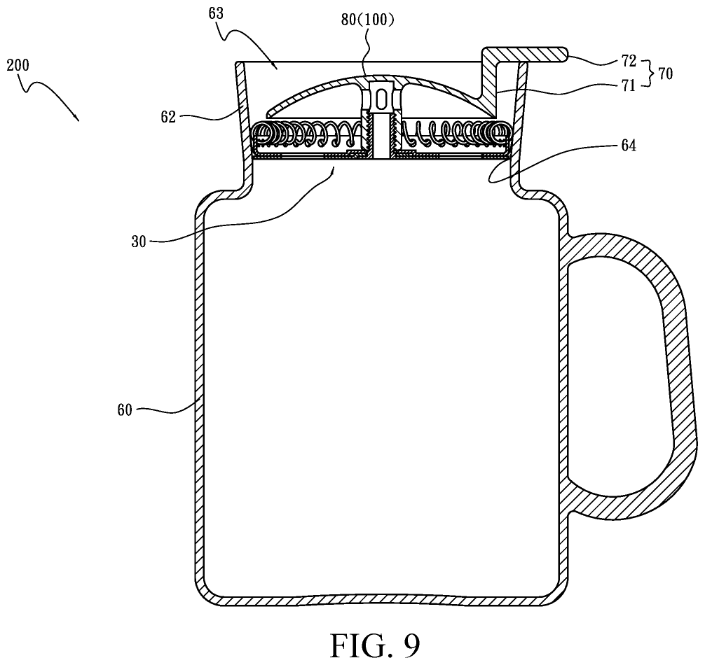

Further referring to FIG. 9, a different embodiment is provided for the container according to the present invention, wherein a difference is that the container opening portion 62 is convergent from the container opening 63 toward the lower side, and the retaining portion 64 is formed of a diameter-reduced inside surface, so that when the filter net assembly 30 and the cover assembly 100 are positioned into the container opening portion 62, the filter net assembly 30 is blocked by the retaining portion 64 (namely the diameter-reduced inside surface) from further moving downward, and the gripping portion of the lift grip 70 connected to the cover 80 is just positioned on the edge rim of the container opening 63, and as such, effects similar to the previous embodiments can be achieved.

I claim:

1. A brewing device, comprising a container, a filter net assembly, a gas guide tube,
a cover assembly, and a lift grip;
wherein the container is formed, in an interior thereof, with a liquid storage space, which has an upper end that forms a container opening portion in communication with the liquid storage space, and an inside surface of the container opening portion forms a retaining portion, and the container opening portion is further formed with a container opening for water ingress and water egress;
the filter net assembly comprises filter pores that allows water to flow in and out and prevents tea leaves from flowing out and comprises a central through-hole to receive a gas guide tube to rotatably extend therethrough; and the filter net assembly is positionable, in a direction from top to bottom, into the container opening portion and is retained by the retaining portion from further moving downward;
the gas guide tube comprises a gas channel, extending through two opposite ends thereof and has an outer circumferential surface that is formed with an external thread, and has a bottom that is formed with a stop portion, and penetrates through the central through-hole of the filter net assembly to screw to a connecting member for combining therewith;
the cover assembly comprises a connecting member and a cover, wherein the connecting member is formed with a threaded hole and has an end combined with the cover and an opposite end that is screwed, through the threaded hole thereof, with an external thread of the gas guide tube to combine the cover and the filter net assembly together; and the cover comprises a circular plate, which has an outside diameter smaller than an inside diameter of the container opening portion; and
the lift grip comprises a longitudinal extension portion and a gripping portion, wherein the gripping portion is connected to the longitudinal extension portion, and the longitudinal extension portion is connected to the cover assembly;
wherein by means of the above structural arrangement, the cover assembly and the filter net assembly are combined together by means of the gas guide tube and the connecting member and are positionable together into the container opening portion of the container, such that the filter net assembly is retained by the retaining portion and is not movable downward without being acted upon by an external force applied thereto, and an annular gap is formed between a cover external circumferential rim and an inside surface of the container opening portion, and a top surface of the cover and the container opening define therebetween a downward recessed water filling trough, and the gas guide tube is in communication with the liquid storage space of the container.

2. The brewing device according to claim 1, wherein the connecting member comprises a bottom plate, and two opposite ends of the bottom plate are each folded upward to form a side plate, and each of the side plates has a top end that is further formed with a bent edge portion extending outward, and an included angle between each of the side plates and the bottom plate is greater than 90 degrees, and the bottom plate is formed, in a center thereof, with a threaded hole, and each of the bent edge portions is formed with a through hole; and an inside bottom surface of the cover is formed with two projecting pegs that extend downward, and each of the projecting pegs is formed with a fitting notch at a same height, and the projecting pegs are received through corresponding ones of the through holes of the two bent edge portions, and an edge of each of the through holes is fit into a corresponding one of the fitting notches, and the threaded hole of the bottom plate is screwed onto the external thread of the gas guide tube.

3. The brewing device according to claim 1, wherein the connecting member comprises a hollow tubular body that is formed, as being directly molded, on a center of a bottom of the cover and is provided, in a bottom portion thereof, with a threaded hole, and is provided, in an outer circumferential surface of a top portion thereof, with a plurality of gas openings, and the threaded hole is screwed onto the external thread of the gas guide tube.

4. The brewing device according to claim 1, wherein the connecting member comprises a hollow tubular body that is formed, as being directly molded, on a center of a bottom of the cover and is provided, in a bottom portion thereof, with a threaded hole, and the threaded hole is screwed onto the external thread of the gas guide tube, and the cover is formed with a gas passage hole at a location corresponding to the hollow tubular body of the connecting member to be in communication with the connecting member.

5. The brewing device according to claim 2, wherein the lift grip is integrally formed with one of bent edge portions of the connecting member.

6. The brewing device according to claim 2, wherein the lift grip is connected to the cover.

7. The brewing device according to claim 3, wherein the lift grip is connected to the cover.

8. The brewing device according to claim 4, wherein the lift grip is connected to the cover.

9. The brewing device according to claim 1, wherein the retaining portion comprises an annular groove, and the filter net assembly comprises an upper fixing plate, a spring ring, a net plate, and a lower fixing plate, wherein the upper fixing plate, the net plate, and the lower fixing plate are respectively formed with central through-holes that are concentrical, and the upper fixing plate and the lower fixing plate are each formed with water flow-through zones penetrating therethrough, and the net plate is formed with the filter pores that are tiny; and the upper fixing plate has an external annular edge that is formed with an annular raised flange that is raised upward, and the annular raised flange is formed with apertures that are arranged at intervals, and the apertures receive the spring ring to extend, in a rotatable manner, therethrough in order to have the spring ring and the upper fixing plate combined together, and the spring ring circumferentially surrounds the external annular edge of the upper fixing plate, and the spring ring and the net plate are fit into and retained in the annular groove.

10. The brewing device according to claim 1, wherein the container opening portion of the container is convergent from the container opening toward a lower side, and the retaining portion is formed of a diameter-reduced inside surface.

11. The brewing device according to claim 9, wherein the external annular edge of the net plate is bent upward to form a curved shape in closely matching engagement with the spring ring.
